(19) United States
(12) Patent Application Publication
(10) Pub. No.: US 2007/0002764 A1
(43) Pub. Date: Jan. 4, 2007

(54) Network arrangement and method for handling sessions in a telecommunications network

(75) Inventor: Dimitris Papadimitriou, Athen (GR)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/480,191

(22) Filed: Jun. 30, 2006

(30) Foreign Application Priority Data
Jun. 30, 2005 (EP) 05014192.8
Jun. 30, 2005 (EP) 05014193.6

(51) Int. Cl. H04J 1/16; H04L 12/56

(52) U.S. Cl. 370/252; 370/401

(57) ABSTRACT

A novel network arrangement and method for handling sessions or calls in a communications network is provided. More particularly, a novel network arrangement and method for avoiding “ghost calls” in IP based communications networks for achieving higher session completion rates is provided. An inventive network arrangement comprises at least the following: a session border controller for monitoring and/or controlling available resources for sessions involving a user terminal and for determining a busy condition if a new session's resource requirements are in excess of the available resources; and an application server for intercepting a busy notification generated towards the new session's origination in response to a busy condition, the application server further configured to either generate a notification towards the new session's destination or redirect the new session to a different destination.

### CROSS REFERENCE TO RELATED APPLICATIONS

This application claims priority of European application No. 05014192.8 EP filed Jun. 30, 2005 and European application No. 05014193.6 filed Jun. 30, 2005, both of the applications are incorporated by reference herein in their entirety.

### FIELD OF INVENTION

The present invention relates to a novel network arrangement and method for handling sessions or calls in a communications network. More particularly, the invention provides a novel network arrangement and method for achieving higher session completion rates in IP based communications networks by avoiding “ghost calls”.

### BACKGROUND OF INVENTION

Modern telecommunication networks often employ voice over Internet Protocol (VoIP) techniques to convey telephone calls between users. A widely used VoIP technique is known as the Session Initiation Protocol (SIP) and defined by IETF RFC 3261.SIP is an application-layer control (signaling) protocol for creating, modifying, and terminating sessions with one or more participants. These sessions include Internet telephone calls, multimedia distribution, and multimedia conferences.

A problem occurs when using SIP if a first user initiates a call, or “session”, the SIP signaling completes successfully and a called second user's terminal equipment starts ringing, but there is not enough bandwidth available for carrying out a voice transaction, for example, if all available bandwidth at the called user's network access is occupied by some other application such as another voice or data transaction. In such cases, if the called user responds to this call, the call, or session, is established but insufficient bandwidth will prevent the users from talking to each other. Such “ghost calls” are clearly undesirable for both users and network operators. For example, since the signaling completed successfully, the calling first user would be charged for a call that was in fact not successful.

IETF RFC 3312 entitled “Integration of Resource Management and SIP” addresses this problem. RFC 3312 describes how network quality of service can be introduced as a precondition for establishment of sessions initiated by the Session Initiation Protocol (SIP). According to RFC 3312, session establishment does not take place, i.e. the called user is not alerted, until certain preconditions, based on network resources availability, for the media stream are met. Initial failure to meet these preconditions may lead to a re-negotiation such as selection of a lower bandwidth codec by the endpoints. At the called endpoint, either the desired resources are reserved or the session establishment will fail. Using the teachings of RFC 3312, “ghost calls” can be avoided.

However, with the methods disclosed in RFC 3312, neither called nor calling user have any control over the completion of the call. When encountering a busy condition, the only option available to the calling user is to reattempt the call at a later time.

### SUMMARY OF INVENTION

It is therefore an object of the present invention to provide a novel network arrangement allowing for further options for either or both the called and calling user. It is another object of the invention to provide a novel method for handling sessions in a telecommunications network.

In accordance with a first aspect of the present invention, there is provided a network arrangement comprising at least the following:
a session border controller for monitoring and/or controlling available resources for sessions involving a user terminal and for determining a busy condition if a new session's resource requirements are in excess of the available resources; and
an application server for intercepting a busy notification generated towards the new session's origination in response to a busy condition, the application server further configured to either generate a notification towards the new session's destination or redirect the new session to a different destination.

In accordance with the first aspect of the invention, there is also provided a method for handling sessions in a telecommunications network, comprising:
in a session border controller, monitoring and/or controlling available resources for sessions involving a user terminal and determining a busy condition if a new session's resource requirements are in excess of the available resources; and
in an application server, intercepting a busy notification generated towards the new session's origination in response to a busy condition and generating a notification towards the new session's destination or redirecting the new session to a different destination.

One advantage of this first aspect of the present invention is that it allows for services that enable the called user to exercise control over calls received at a time when not enough resources are available to successfully complete the call.

In accordance with a second aspect of the invention, there is provided a network arrangement comprising at least the following:
a session border controller for monitoring and/or controlling available resources for sessions involving a user terminal and for determining a busy condition if a new session's resource requirements are in excess of the available resources and for notifying an origination of the new session of a busy condition; and
an application server for receiving a session completion request from the new session's origination and for establishing the session after the busy condition has ceased.

In accordance with the second aspect of the invention, there is also provided a method for handling sessions in a telecommunications network, comprising:
in a session border controller, monitoring and/or controlling available resources for sessions involving a user terminal and determining a busy condition if a new session's resource requirements are in excess of the available resources and notifying an origination of the new session of a busy condition; and
in an application server, receiving a session completion request from the new session's origination and establishing the session after the busy condition has ceased.

One advantage of this second aspect of the present invention is that it allows for services that enable the calling user to request the completion of the session establishment upon cessation of the busy condition. The invention is useful if the busy condition is encountered at a destination and also if the busy condition is encountered at the new session's origination, i.e. if a calling user's available resources are insufficient to accommodate the newly requested session.

A preferred signaling protocol for use with the present invention is the Session Initiation Protocol SIP.

Resource control and/or monitoring may be accomplished by monitoring and/or controlling at least one of the following parameters: available bandwidth; number of available media streams; any other parameter relating to a user terminal and representing a resource subject to a physical or other limitation.

To determine the cessation of the busy condition, a preferred method is that the application server subscribes to the session border controller's monitoring function in order to be notified by the border controller when the busy condition has ceased for the previously insufficient resource.

In an alternative, the cessation of the busy condition can be determined by a Presence service. Presence service refers to the ability to access in real-time information about a subscriber's status, communications capabilities, and/or preferences. Presence is relevant to virtually every means of communication: mobile, VoIP, e-mail, etc. “Status” refers to the subscriber's availability, free/busy condition, etc. “Capabilities” include information such as support of video on a VoIP phone, support of voice mail on the mobile phone, etc. Finally, “preferences” include properties like call routing information (e.g. “contact me at my mobile first, then try home”).

The Presence service may comprise presence information of a subscriber and information on a subscriber's devices, services and service components being managed by a network. A presence entity or Presentity may comprise the subscriber, the subscriber's devices, services and the service components. A Watcher, on the other hand, is any uniquely identifiable entity that uses the presence service to request presence information about a Presentity.

The Presence service may provide access to presence information to be made available to other subscribers or services. Applications of the Presence service include the creation of enhanced rich multimedia services. In conjunction with the present invention, the Presence service may be used for monitoring the busy conditions at a busy endpoint or presentity, on behalf of the requesting party or watcher. This would allow the requesting user to complete the session as soon as the busy conditions are no longer valid existent.

### BRIEF DESCRIPTION OF THE DRAWINGS

In the following, preferred embodiments of the invention will be described with reference to two figures.

FIG. 1 shows an exemplary network arrangement in accordance to the present invention; and

FIG. 2 shows another exemplary network arrangement in accordance to the present invention.

### DETAILED DESCRIPTION OF INVENTION

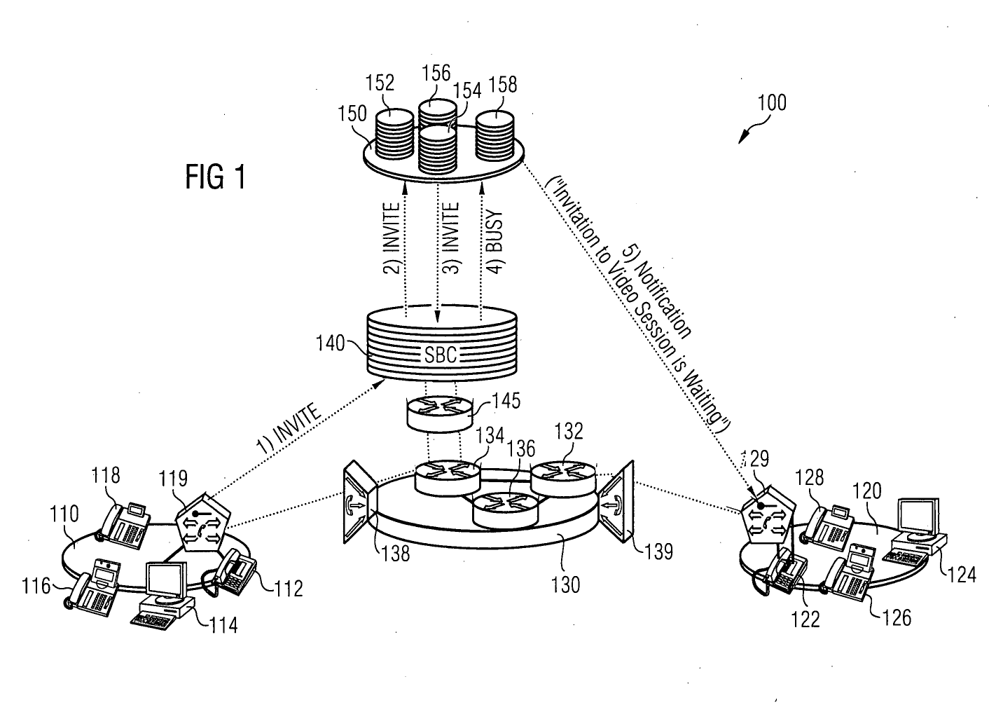

In FIG. 1, there is shown an exemplary network arrangement 100 comprising user terminal equipment 110, 120 connected to a packet backbone network 130, a Session Border Controller or SBC 140, and an application server farm 150.

User terminal equipment 110, 120 may comprise either one or a combination of the following: analog telephony equipment 112, 122; personal computers 114, 124; video telephony equipment 116, 126; ISDN or other digital telephony equipment 118, 128; and SIP gateways 119, 129. In alternative configurations, SIP phones and/or SIP clients are used instead of SIP gateways 119, 129 and legacy equipment—not shown.

The packet backbone network 130 may comprise routing equipment such as routers 132, 134, 136. For connecting the user terminal equipment 110, 120 to the packet backbone network 130 a variety of so-called access technologies may be employed such as T1/E1 lines, DSL techniques, Ethernet techniques such as Metropolitan Ethernet, or wireless techniques such as Wireless Local Loop (WLL). The illustrative embodiment of FIG. 1 comprises optional multiplexer/concentrators 138, 139 for connecting to user terminal equipment 110, 120, respectively.

Depending on a chosen access technology, various access protocols may be employed as is well known in the art. The protocol hierarchy will, however, in many cases comprise the Internet Protocol (IP) as a network layer packet protocol. IP may be used throughout the packet backbone network 130 and for connecting user terminal equipment 110, 120. For residential access, the Peer-to-Peer Protocol (PPP), the Peer-to-Peer Protocol over Ethernet (PPPoE), or the Peer-to-Peer Tunneling Protocol (PPTP) are often used for connecting user terminal equipment 110, 120 to the packet backbone network 130. These protocols, in turn, allow the exchange of IP packets.

SBC 140 may be coupled to packet backbone network 130 directly or by means of an edge router 145. SBC 140 is also communicatively coupled to application servers 152-158 of application server farm 150. Of course, a single application server 152 may alternatively be chosen if suitable to perform all required application server functions—not shown.

SIP Call Control, or signaling, is symbolized throughout by dashed lines.

In accordance with the invention, SBC 140 is used for resource availability inspection before a session is offered to the session's destination. In the example shown in FIG. 1, it is assumed that a session originates from a first user's terminal equipment 110 (also denoted calling party or origination)—step 1. It is further assumed that the session's destination is a second user's terminal equipment 120 (also denoted called party).

One of the functions of SBC platforms such as SBC 140 is resource management. VoIP traffic, due to its requirement for continuous low-latency high-packet rate flows, is sensitive to any bandwidth restrictions. Therefore, SBC platforms are typically employed for providing bandwidth consumption based policies that enable the limiting of bandwidth consumption per end user or enterprise customer. Other resources may also be monitored and/or controlled based on other subscription or policy information such as allowable number of simultaneous sessions.

For example, a bandwidth policy may be applied by examining in real-time the bandwidth used by both outgoing and incoming active media streams, inspecting new sessions for their required bandwidth usage or codec profile, and dropping new sessions that could cause the total bandwidth consumption to exceed a pre-defined upper bound. Such pre-defined upper bound may also be a physical bandwidth limitation of the chosen (access) transmission technology.

Instead of the parameter “bandwidth”, other parameters may be monitored and/or controlled such that the number of active media streams does not exceed a pre-defined limit.

Restrictions may be physical in nature or may result from business models or Service Level Agreements (SLA). If any such restriction leads to a new session being dropped because the new session's resource requirements exceed the available resources, this condition is termed “busy condition”. Upon encountering a busy condition, the SBC 140 creates a corresponding busy notification for informing the calling party 110 of the busy condition.

In accordance with the invention, SBC 140 checks for busy conditions before offering the SIP INVITE message to destination 120, while in prior art implementations and without using the invention, the INVITE message would immediately be sent to the destination. Triggered by the SDP response as contained in the 183 “Session Progress” message, the resource authorization would then take place.

If a busy condition is encountered then the SBC will return a 486 “Busy Here” message, which will be intercepted by or redirected to a corresponding terminating Application Server (AS) 152-158 controlling either one or both of the services “Session Redirection” or “Session Waiting”, if the called party has subscribed to any of these services—steps 2, 3, 4.

In case Session Waiting has been subscribed by the called user, the corresponding terminating Application Server would notify the called party that a session is waiting—step 5. Such notification could be presented visually or aurally to the called party. Then, the called party 120 would be aware of the fact that he/she is invited to a session that cannot be successfully established, and could react correspondingly. For example, the called party could free some bandwidth, e.g. by canceling a less important session or by using the Call Hold service. Those with skills in the art will without the use of inventive faculty be able to implement enhanced SIP clients or SIP terminals configured to offer corresponding procedures to the user.

In case Session Redirection has been subscribed by the called user, the session will be redirected to a different destination—not shown. The called user may specify a suitable destination.

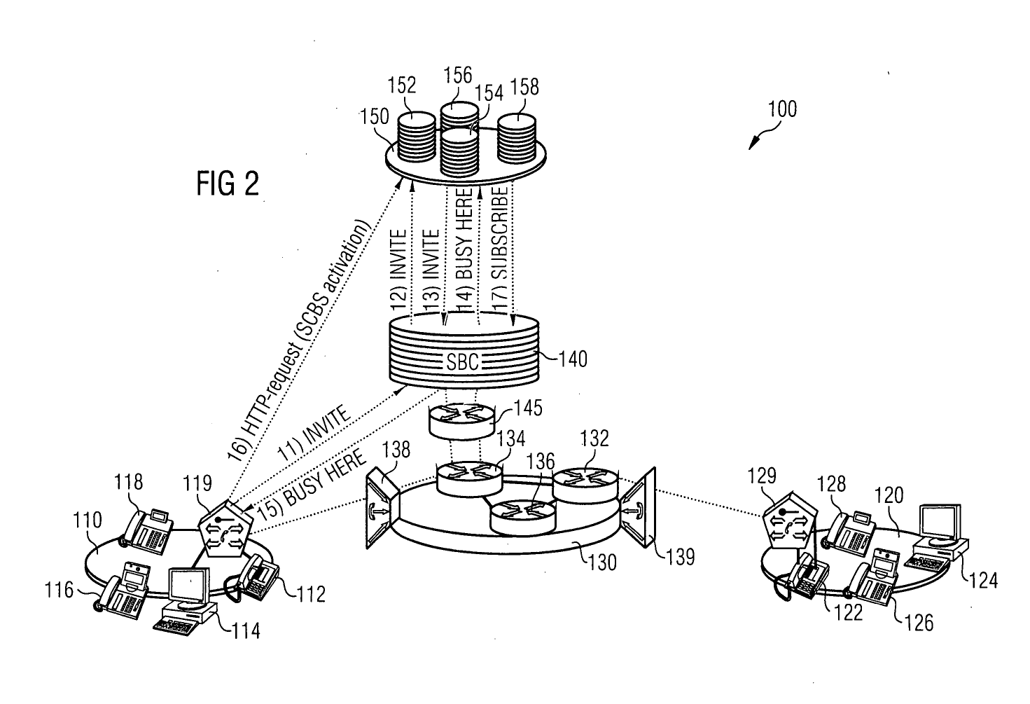

If the called subscriber has subscribed to either or both services “Session Waiting” or “Session Redirection” but deactivated it, temporarily or permanently, a busy notification, for example notification 486 “Busy Here” will be forwarded to origination of the session—step 15 of FIG. 2. The calling user may then request for example the session to be completed upon the called party becoming available again by invoking a “Session Completion on Busy” type of service, as explained in the following with reference to FIG. 2.

FIG. 2 again shows network 100 of FIG. 1 comprising the user terminal equipment 110, 120 connected to packet backbone network 130, SBC 140, and application server farm 150.

In the example shown in FIG. 2, it is again assumed that a session originates from the first user's terminal equipment 110 (also denoted calling party or origination)—step 11. It is further assumed that the session's destination is a second user's terminal equipment 120 (also denoted called party).

If a busy condition is encountered then the SBC will return a 486 “Busy Here” message, which in embodiments may optionally be intercepted by or redirected to a corresponding terminating Application Server (AS) 152-158 controlling either one or both of the services “Session Redirection” or “Session Waiting” as explained above with reference to FIG. 1, if the called party has subscribed to any of these services—optional steps 12, 13, 14.

If the services “Session Redirection” and/or “Session Waiting” are not activated or fail to resolve the busy condition, SBC 140 creates a corresponding busy notification for informing the calling party 110 of the busy condition—shown as step 15 in FIG. 2.

Upon receiving the busy notification in step 15, for example as 486 “Busy Here” message, at the calling user's equipment the session (or call) completion service can be invoked for automatically reattempting (or completing) the session upon the resource becoming available again. Such request is forwarded to a corresponding call completion application server 152—step 16.

It shall be noted that the lack of available resources may occur at the session's destination 120. When invoking the session completion service, the calling user invokes a “Session Completion on Busy Subscriber” (SCBS) service, which is described in more detail with reference to an example in the following. In the example, a called SIP subscriber 120 is invited to a video conference. However, there is not enough bandwidth to establish the session because the called subscriber 120 is at the same time downloading data from the Internet and in addition has an active voice call. The SBC 140 detects the busy condition and returns a 486 “Busy Here” message—step 15. The calling user 110 (i.e., the originator of the video session) activates SCBS through an http-request (step 16), which is handled by application server 152, so that the video session can be established as soon as the required bandwidth is released. To achieve this, the application server 152 may monitor the bandwidth resources at the terminating side by “subscribing” to the terminating endpoint—step 17. When bandwidth is available the application server 152 “invites” the originator of the session 110, and as soon as the originator answers, the application also “invites” the destination 120—not shown. Alternatively, a presence service may be utilized for monitoring the busy conditions.

It shall further be noted that the lack of available resources may also occur at the session's origination 110. A busy condition at the origination may for example occur if the calling user has too many active sessions and the additional session would not be permitted under the user's SLA or would require more bandwidth than still available. When invoking the session completion service, the calling user in this case invokes a “Originating Session Completion on Busy” (OSCB) service, which may be handled as described in the example above except that the busy condition to be monitored exists at the origination of the call—not shown.

1. An arrangement within a telecommunications network, comprising:
a session border controller for evaluating available resources for a session involving a user terminal and for determining a busy condition if a resource requirement for the session exceeds available resources; and
an application server for intercepting a busy notification generated towards an origination of the session in response to a busy condition, the application server configured to redirect the new session to a different destination or to generate a session waiting notification toward a destination of the session.

2. The arrangement according to claim 1, wherein signaling in the arrangement is based on a Session Initiation Protocol (SIP).

3. The arrangement according claim 1, wherein the evaluating includes monitoring a resource based on a parameter selected from the group consisting of available bandwidth, number of available media streams, a user terminal resource parameter, and combinations thereof.

4. The arrangement according claim 1, wherein the evaluating includes controlling a resource based on a parameter selected from the group consisting of available bandwidth, number of available media streams, a user terminal resource parameter, and combinations thereof.

5. A method for handling a session within a telecommunications network, comprising:
evaluating a resource by a session border controller for a session involving a user terminal;
determining by the session border controller a busy condition if a resource requirement for a session exceeds available resources;
intercepting a busy notification generated towards an origination of the session, the busy notification generated in response to a busy condition; and
generating a session waiting notification towards a destination of the session.

6. The method according to claim 5, further comprising redirecting the session to a different destination.

7. The method according to claim 5, wherein signaling within the telecommunications network is based on a Session Initiation Protocol (SIP).

8. The method according to any of claims 5, wherein the evaluating includes monitoring the resource based on a parameter selected from the group consisting of available bandwidth, number of available media streams, a user terminal resource parameter, and combinations thereof.

9. The method according to any of claims 5, wherein the evaluating includes controlling the resource based on a parameter selected from the group consisting of available bandwidth, number of available media streams, a user terminal resource parameter, and combinations thereof.

10. An arrangement within a telecommunications network, comprising:
a session border controller for evaluating available resources for sessions involving a user terminal and for determining a busy condition if a resource requirement of a session exceeds available resources and for notifying an origination of the session of a busy condition; and
an application server for receiving a session completion request from the origination and for establishing the session after the busy condition has ceased.

11. The arrangement according to claim 10, wherein the application server comprises a subscriber mechanism for subscribing to the evaluating function of the session border controller in order to determine the cessation of the busy condition.

12. The arrangement according to claim 10, wherein the application server comprises a presence service for determining the cessation of the busy condition.

13. The arrangement according to claim 10, wherein signaling in the arrangement is based on a Session Initiation Protocol (SIP).

14. The arrangement according to claim 10, wherein the session border controller evaluates available resources.

15. The method according to any of claims 14, wherein the evaluating includes monitoring the resource based on a parameter selected from the group consisting of available bandwidth, number of available media streams, a user terminal resource parameter, and combinations thereof.

16. The method according to any of claims 14, wherein the evaluating includes controlling the resource based on a parameter selected from the group consisting of available bandwidth, number of available media streams, a user terminal resource parameter, and combinations thereof.

17. A method for handling a session within a telecommunications network, comprising:
evaluating an available resource by a session border controller for a session involving a user terminal;
determining a busy condition if a resource requirement of the session exceeds available resources;
notifying an origination of the session of a busy condition;
receiving a session completion request from the origination by an application server; and
establishing the session after the busy condition has ceased.

18. The method according to claim 17, further comprising subscribing by the application server to the evaluation function for determining the cessation of the busy condition.

19. The method according to claim 17, wherein the cessation of the busy condition is determined by a presence service.

20. The method according to claim 17, wherein signaling in the telecommunications network is based on a Session Initiation Protocol (SIP).

21. The method according to claim 17, wherein the evaluating includes monitoring the resource based on a parameter selected from the group consisting of available bandwidth, number of available media streams, a user terminal resource parameter, and combinations thereof.

22. The method according to claim 17, wherein the evaluating includes controlling the resource based on a parameter selected from the group consisting of available bandwidth, number of available media streams, a user terminal resource parameter, and combinations thereof.
